(19) United States
(12) Patent Application Publication
(10) Pub. No.: US 2005/0236248 A1
(43) Pub. Date: Oct. 27, 2005

(54) Electrically actuated mechanical disconnect

(75) Inventor: Mark A. Joki, Dover, OH (US)

Correspondence Address: MICHAEL BEST & FRIEDRICH, LLP, 100 E WISCONSIN AVENUE, MILWAUKEE, WI, 53202, US

(73) Assignee: Timken US Corporation, Torrington, CT (US)

(21) Appl. No.: 11/111,601

(22) Filed: Apr. 21, 2005

Related U.S. Application Data
(60) Provisional application No. 60/564,072, filed on Apr. 21, 2004.

(51) Int. Cl. F16D 21/00; F16D 23/00

(52) U.S. Cl. 192/48.3; 192/48.92; 192/93 A

(57) ABSTRACT

An axial actuator assembly is coupled with a cylindrical member. The axial actuator assembly includes a first ring positioned about the cylindrical member and including a first surface. A second ring is positioned about the cylindrical member and includes a first surface engaged with the first surface of the first ring. An actuator is operable to cause relative rotation between the first and second rings to spread the first and second rings apart. The axial actuator assembly can form part of a clutch assembly so that the spreading of the first and second rings operates to engage the cylindrical member with a driven member.

### RELATED APPLICATIONS

This application claims priority to U.S. Provisional Patent Application Ser. No. 60/564,072 filed Apr. 21, 2004, the entire contents of which are hereby incorporated by reference.

### BACKGROUND

The present invention relates to an electrically actuated mechanical actuator. More particularly, the present invention relates to an electrically actuated axial actuator.

It is desirable to use electrical signals to control mechanical power flow such as in a positive differential lock for an axle. The typical approach is to use a sliding coupling with a shift fork. The shift fork moves on a linear guide and is driven by a motor. However, such devices include a number of complex parts, are relatively large in size, and require relatively large actuation power.

### SUMMARY

The present invention provides an axial actuator supported on a cylindrical member.

In one embodiment, the axial actuator includes a first ring positioned about the cylindrical member and including a first surface. A second ring is positioned about the cylindrical member and includes a first surface engaged with the first surface of the first ring. An actuator is operable to cause relative rotation between the first and second rings to spread the first and second rings apart. The axial actuator assembly can form part of a clutch assembly so that the spreading of the first and second rings operates to engage the cylindrical member with a driven member.

In another embodiment, the invention provides a mechanical clutch assembly including a drive member, a driven member spaced from the drive member, and an actuator assembly operable to selectively engage the drive member and the driven member. The actuator assembly includes a first ring positioned about the drive member and including a first surface, a second ring positioned about the drive member and including a first surface engaged with the first surface of the first ring, and an actuator operable to cause relative rotation between the first and second rings to spread the first and second rings apart, thereby causing engagement of the drive member and the driven member.

The invention also provides a method of operating an axial actuator assembly supported on a cylindrical member. The axial actuator assembly includes first and second rings positioned about the cylindrical member, the first and second rings including respective first surfaces engaging one another. The method includes creating relative rotation between the first and second rings so that the relative rotation causes the first and second rings to spread apart from one another. The axial actuator assembly can form part of a clutch assembly so that the spreading of the first and second rings operates to engage the cylindrical member with a driven member.

Other aspects of the invention will become apparent by consideration of the detailed description and accompanying drawings.

### BRIEF DESCRIPTION OF THE DRAWINGS

FIG. 1 is a partial sectional view of an assembly embodying this invention shown in a first, disengaged configuration.

FIG. 2 is a partial sectional view of the assembly of FIG. 1, shown in a second, engaged configuration.

FIG. 3 is a partial end view taken along line 3-3 of FIG. 1.

FIG. 4 is a partial end view taken along line 4-4 of FIG. 2.

FIGS. 5 and 6 are schematic diagrams of the interaction of the profiled surfaces of the wave rings and their interaction with the actuator rings and solenoid armature.

FIG. 7 is a partial sectional view of an assembly that is a second embodiment of the invention shown in a first, disengaged configuration.

FIG. 8 is a partial isometric view of the stop ring shown in FIG. 7.

FIG. 9 is a partial isometric view of the cam ring shown in FIG. 7.

FIG. 10 is a schematic diagram of the interaction of the profiled surfaces of the stop ring and the cam ring.

FIG. 11 is a partial sectional view of the assembly of FIG. 7, shown in a second, engaged configuration.

FIG. 12 is a partial section view taken along line 12-12 of FIG. 11.

FIG. 13 is a partial section view similar to FIG. 12 but showing the actuator rod retracted to initiate disengagement of the clutch.

FIG. 14 is a partial sectional view of the assembly of FIG. 7 showing the clutch actuator in the disengaged state while the clutch remains engaged while transmitting torque.

FIG. 15 is a partial isometric view showing the roller clutch of FIG. 7.

FIG. 16 is a partial section view of the roller clutch of FIG. 15.

FIG. 17 is a partial sectional view of an assembly that is third embodiment of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

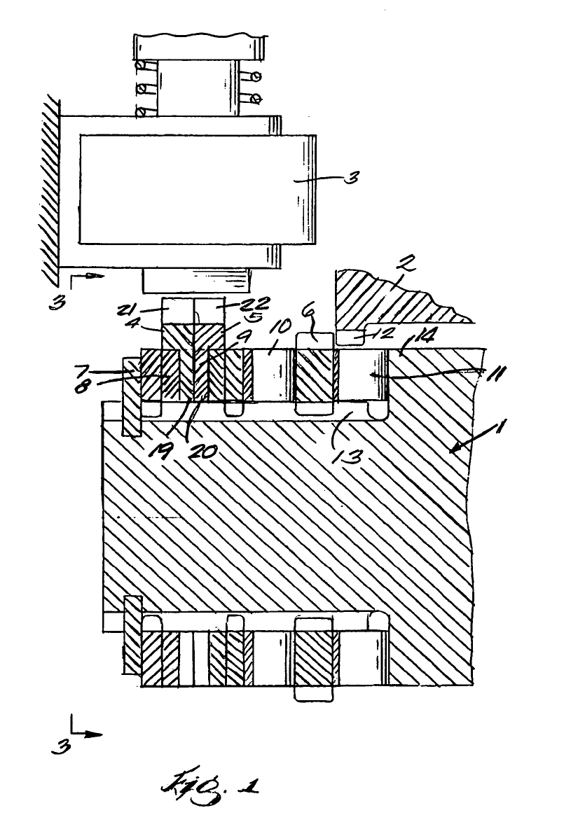

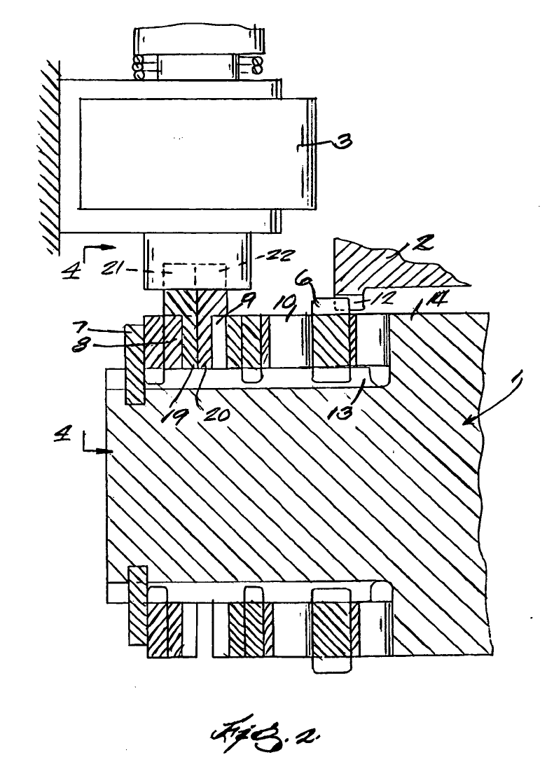

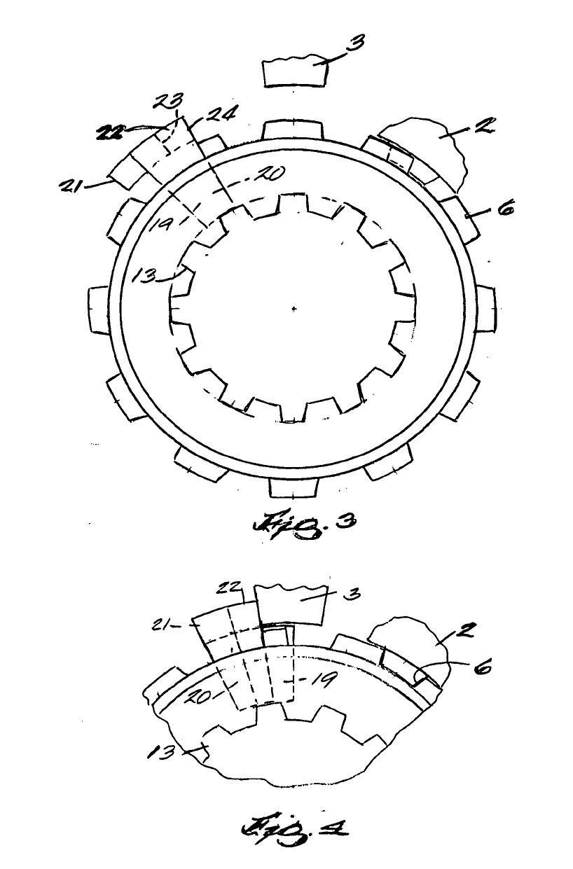

FIGS. 1-6 illustrate a first embodiment of the electrically actuated mechanical clutch assembly of the invention. Referring to FIGS. 1-4, an outer rotating member or shaft 2 has a spline 12 on its generally cylindrical inner periphery. An inner rotating member or shaft 1 has a spline 13 on a generally cylindrical outer peripheral surface. A solenoid 3 has an armature which, when actuated, moves radially inward (see FIGS. 2 and 4), and when deactivated, spring returns radially outward (see FIGS. 1 and 3). The inner rotating member 1 has along its splined outer periphery a first wave ring 8, a second wave ring 9, a first spring 10, a coupling ring 6, and a second spring 11. These components are axially contained between a shoulder 14 and snap ring 7. Radially outward from the first wave ring 8 and second wave ring 9 are first actuator ring 4 and second actuator ring 5, respectively.

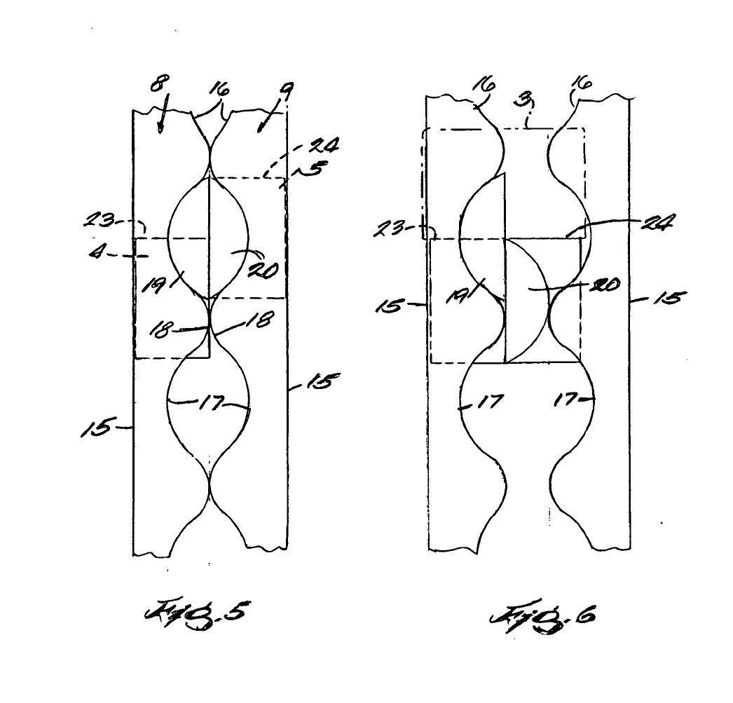

Referring to FIGS. 5 and 6 the wave rings 8 and 9 each have one plain face 15 and a circumferentially waved face 16 having alternating troughs 17 and ridges 18. In the illustrated embodiment, the waved face 16 has a generally sinusoidal configuration, however, other geometric configurations for the waved face 16 can also be used. The wave rings 8, 9 are preferably molded from plastic, but may be manufactured from other natural or synthetic materials. The waved faces 16 of the wave rings 8 and 9 face each other.

The actuator rings 4 and 5 each have a plurality of radial projections 19, 20, respectively (only one of each is shown), on their inner periphery at a spacing corresponding to the wavelength of the troughs 17 and ridges 18 on the wave rings 8 and 9. The actuator rings 4, 5 are preferably molded from plastic, but may be manufactured from other natural or synthetic materials. The projections 19, 20 extend between the wave rings 8 and 9 and face the respective wave faces 16. In the illustrated embodiment, each projection 19, 20 has a convex surface configured to fit within a respective trough 17. Of course, the geometry of the projections 19, 20 can vary depending on the configuration of the waved faces 16.

The actuator rings 4 and 5 also have a plurality of radially outward projections 21, 22, respectively (only one of each is shown), on their outer periphery which are configured to be engaged by the armature of solenoid 3. The outward projections 21, 22 are rotationally offset from one another such that projection 21 has a stop surface 23 offset by a half-wavelength from a stop surface 24 of projection 22 (see FIGS. 3 and 5). As such, when aligned by the solenoid 3 armature (as shown in FIGS. 4 and 6), the inward projections 19, 20 are rotationally offset by one-half of the wavelength of the face waves 17, 18 of wave rings 8 and 9.

FIG. 5 shows the wave rings 8, 9 in the free state, rotating without the solenoid 3 actuated. The convex surfaces of the actuator inner projections 19, 20 cause the inner projections 19, 20 to self-align such that they are nested in the respective troughs 17 under the spring load, causing the width over the two wave rings 8, 9 to be a minimum. Referring to FIG. 6, the wave rings 8 and 9 are illustrated rotating in a motion of the ring surface from bottom to top of the drawing page. The respective stop surfaces 23, 24 of the outer projections 21, 22 of the actuator rings 4, 5 are individually stopped by the extended solenoid 3 armature, causing the inner projections 19, 20 of the actuator rings 4, 5, and the rings 4, 5 themselves, to be rotationally offset by one-half wavelength, thereby spreading the wave rings 8, 9. Referring back to FIG. 2, when the wave rings 8 and 9 are spread, the coupling ring 6 engages both the splines 12, 13 in the outer member 2 and in the inner member 1, transferring torque between them. Spring 10 is preferably higher stiffness than spring 11 so maximum axial travel of the actuation is imparted to the coupling ring 6. Wave spring 11 generally only requires sufficient force to assure retracting the coupling ring 6 under a no-load condition.

FIGS. 7-16 illustrate a second embodiment of an electrically actuated mechanical clutch assembly 50 of the invention. In the illustrated embodiment, the clutch assembly 50 is shown being used in conjunction with a bi-directional roller or slipper clutch 54 of the type described in pending PCT Application No. PCT/US04/034656, the entire contents of which are hereby incorporated by reference.

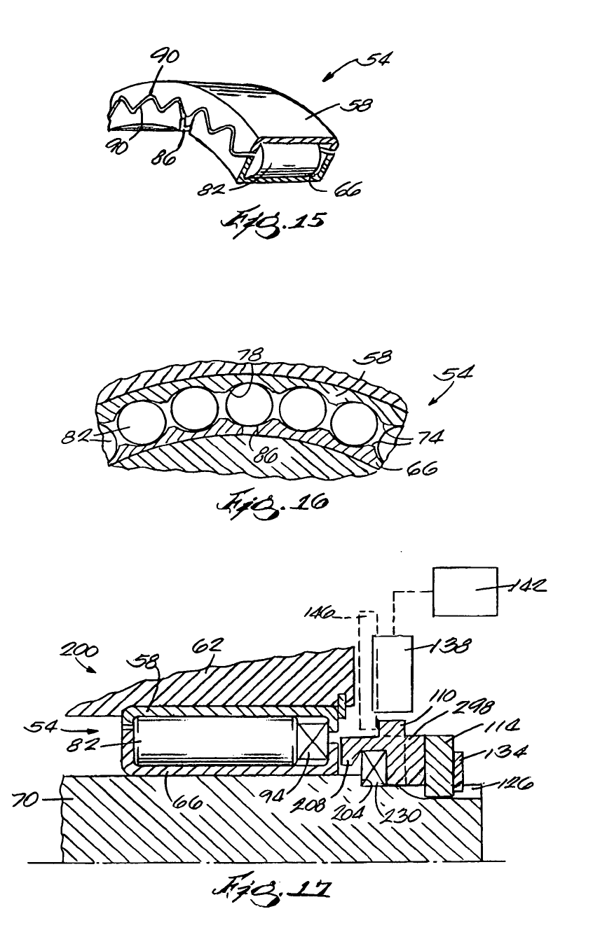

Referring initially to FIGS. 7, 15, and 16, an outer race 58 of the clutch 54 is pressed in an outer ring or shaft 62. An inner race 66 is loose fit over a shaft 70. With reference to FIGS. 15 and 16, both the inner race 66 and the outer race 58 have an equal number of axial ridges 74 forming pockets 78 into which rollers 82 are placed. The inner race 66 is slit through axially (see slit 86 in FIGS. 15 and 16), making it a non-continuous ring. The inner and outer races 66, 58 have mutually engaging features in the form of cooperating wave or tooth-shaped wall surfaces 90 (see FIG. 15) that prevent the inner and outer races 66, 58 from relatively rotating away from a neutral or disengaged position (as shown in FIGS. 7 and 15). An internal spring 94 is positioned between the inner and outer races 66, 58 and biases the inner race 66 axially to maintain engagement of the cooperating wave-shaped surfaces 90 for the neutral or disengaged state of the clutch 54.

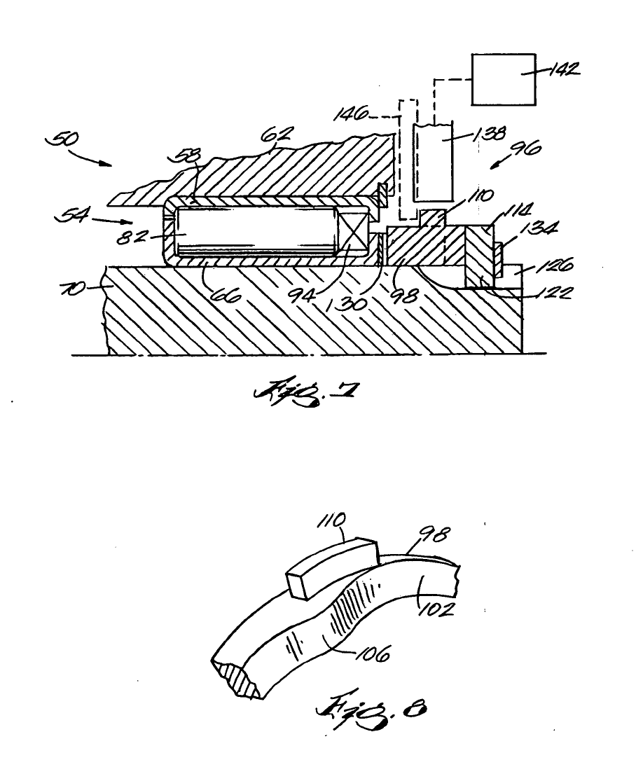

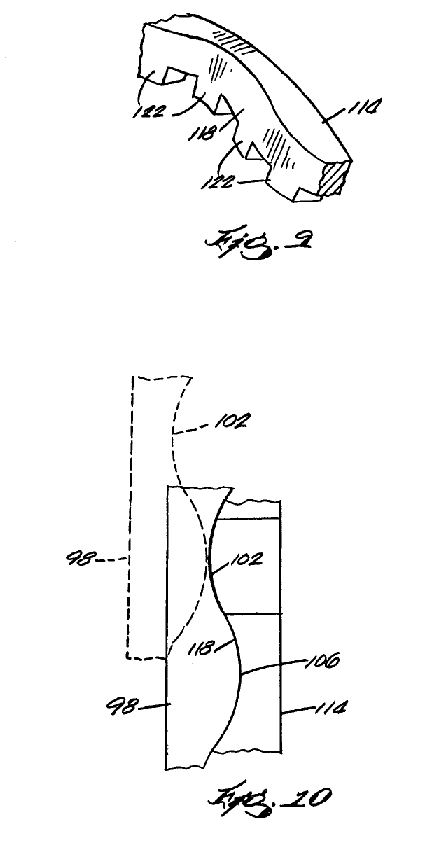

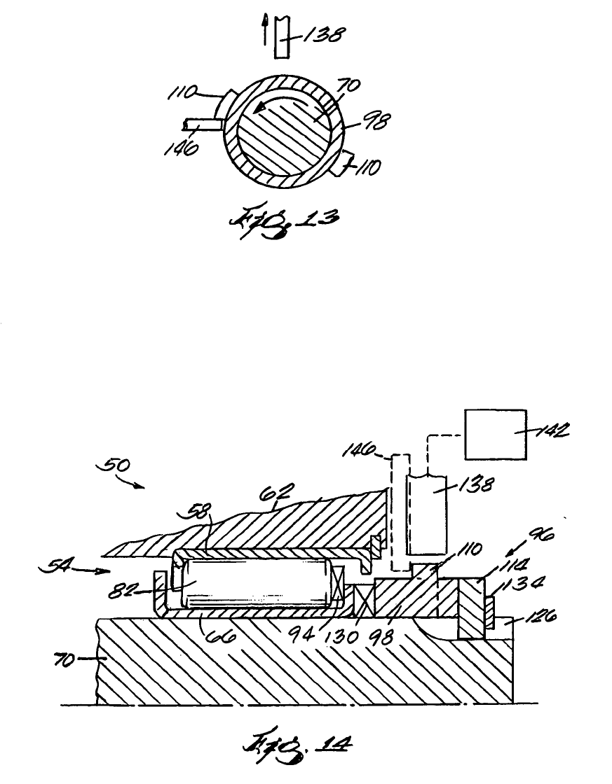

The assembly 50 includes an actuator assembly 96 that is electrically operable to move the clutch 54 between the neutral or disengaged state (shown in FIG. 7), and the driving or engaged state (shown in FIGS. 11 and 14). Referring now to FIGS. 7, 8, and 10, the actuator assembly 96 includes a stop ring 98 supported on the shaft 70 so as to be generally free to rotate about the shaft 70. As best seen in FIGS. 8 and 10, the stop ring 98 has a wave-shaped profile on a first face 102. In the illustrated embodiment, the wave-shaped profile on the first face 102 has at least two high spots or peaks 106 (only one is shown in FIGS. 8 and 10). The stop ring 98 further includes at least one radially outwardly extending tab 110 that is operable to selectively stop rotation of the stop ring 98 with respect to the shaft 70, as will be described in detail below.

With reference to FIGS. 7, 9 and 10, the actuator assembly 96 further includes a cam ring 114 that includes a wave-shaped profile on a first face 118 (see FIGS. 9 and 10) that is in facing relation to the first face 102 of the stop ring 98. As shown in FIGS. 7 and 9, the cam ring 114 is rotationally fixed to the shaft 70 via engagement between inwardly extending teeth 122 on the cam ring 114 and splines 126 on the shaft 70. Of course, other methods for fixing the cam ring 114 relative to the shaft 70 can also be used.

The stop ring 98 and the cam ring 114 are preferably molded from plastic, but may be manufactured from other natural or synthetic materials. In the illustrated embodiment, the wave-shaped profiles of the first surfaces 102, 118 have a generally cooperating sinusoidal configuration with alternating troughs and ridges. This configuration keeps the first surfaces 102, 118 in line contact with one another during relative rotation. However, other geometric configurations for the profiles of the first surfaces 102, 118 can also be used.

As seen in FIG. 7, a spring 130 having a significantly lower spring rate than the internal spring 94 is interposed between the inner race 66 and the stop ring 98. As seen in FIG. 7, the spring 130 is shown in its collapsed or compressed state. A snap ring 134 is mounted on the shaft 70 and engages the cam ring 114 such that the stop ring 98 and the cam ring 114 are retained axially between the spring 130 and the snap ring 134.

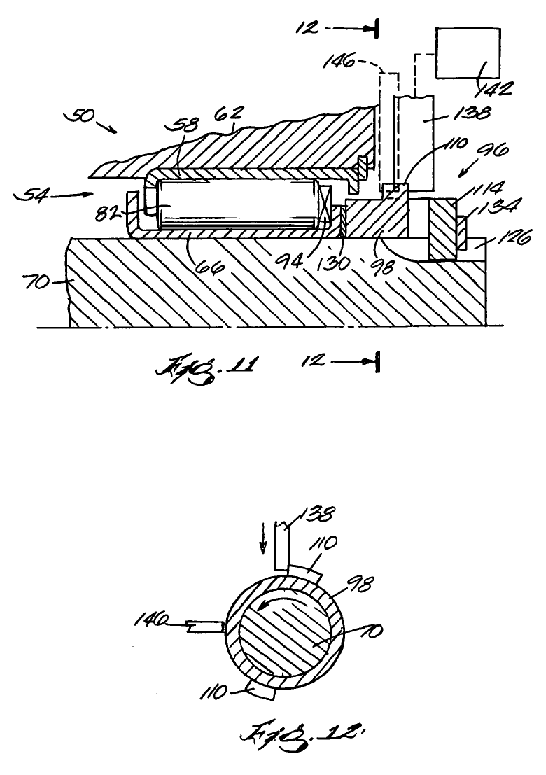

With continued reference to FIG. 7, the actuator assembly 96 further includes an actuator member or rod 138 that can be moved radially by a solenoid 142 (shown schematically in FIG. 7) or other suitable device. In the illustrated embodiment, the actuator rod 138 is in the retracted position shown in FIG. 7 when the solenoid 142 is deenergized, and is moved to the extended position shown in FIG. 11 when the solenoid 142 is energized. Alternatively, the solenoid could be energized to hold the actuator rod 138 in the retracted position and deenergized to move the actuator rod 138 to the extended position. A reset member or rod 146 is fixed radially, axially, and rotationally with respect to the shaft 70, and is spaced rotationally and axially from the actuator rod 138 (see FIGS. 12 and 13). The operation of the actuator rod 138 and the reset rod 146 will be described in greater detail below.

Operation of the actuator assembly 96 will now be described. FIG. 7 illustrates the clutch 54 in the disengaged or neutral position, as dictated by the actuator assembly 96 state. In this state, the first face 102 of the stop ring 98 and the first face 118 of the cam ring 114 are nested together as shown in FIG. 10 such that the stop ring 98 and the cam ring 114 are positioned tightly against one another. The engagement between the wave-shaped profiles of the first faces 102 and 118 causes the stop ring 98 to rotate with the cam ring 114 and the shaft 70. The actuator rod 138 is in the retracted position so as not to engage with the radially extending tabs 110 on the stop ring 98. Furthermore, the reset rod 146 is axially offset from the radially extending tabs 110 on the stop ring 98. Therefore, neither the actuator rod 138 nor the reset rod 146 interfere with the rotation of the stop ring 98 when the actuator assembly 96 is in the state illustrated in FIG. 7.

To engage the clutch 54 and thereby transfer power from the shaft 70 to the outer ring 62, the actuator assembly 96 is operated by energizing the solenoid 142 to move the actuator rod 138 to the extended position shown in FIGS. 11 and 12. A radially extending tab 110 on the stop ring 98 will now engage the actuator rod 138, thereby stopping the rotation of the stop ring 98. The relative rotation of the stop ring 98 with respect to the cam ring 114 causes the wave-shaped profiles of the first surfaces 102, 118 to move out of the nested engagement shown in solid line in FIG. 10 such that the profiles at least temporarily move to a peak-to-peak engagement relation as shown in phantom in FIG. 10, causing the stop ring 98 to be moved axially toward the inner race 66 (left in FIG. 11). The spring 130 may be compressed even further, however, the movement of the stop ring 98 causes the internal spring 94 to collapse and the inner race 66 to move axially (left in FIG. 11). As the inner race 66 moves axially relative to the outer race 58, the cooperating wave or tooth-shaped wall surfaces 90 disengage and allow the inner and outer races 66, 58 to rotate relative to one another until the rollers 82 jam against the ridges 74 formed in the inner and outer races 66, 58 at a shallow contact angle (2-7 degrees from perpendicular). This engages the clutch 54. When the clutch 54 is engaged, the inner race 66 is pressed against the shaft 70 and transfers torque from the shaft 70 to the outer ring 62.

To disengage the clutch 54, the actuator assembly 96 is actuated by deenergizing the solenoid 142 to retract the actuator rod 138 to the position shown in FIG. 13. With the actuator rod 138 retracted, the radially extending tab 110, and therefore the stop ring 98 is free to rotate with the cam ring 114 and the shaft 70. However, the radially extending tab 110, which is still actually shifted (left in FIG. 11) due to the axial movement of the stop ring 98 to the position shown in FIG. 11, engages the reset rod 146. Upon engagement with the reset rod 146, the stop ring 98 is urged by the spring 130 toward the cam ring 114 such that the wave-shaped profiles of the first surfaces 102, 118 are moved into the nested engagement shown in solid lines in FIG. 10, allowing the stop ring 98 to move axially toward the cam ring 114 (to the right in FIG. 14). At this point, the radially extending tab 110 is again clear from engagement with the actuator rod 138 (which is retracted) and the reset rod 146 (which is axially spaced from the tab 110) such that the stop ring 98 rotates with the cam ring 114 and the shaft 70.

As shown in FIG. 14, the clutch 54 will remain engaged via the axial offset between the inner and outer races 66, 58 until there is a torque reversal between the shaft 70 and outer ring 62. The torque reversal causes the roller contact force to disappear, thereby releasing the rollers 82 from the jammed configuration. The internal spring 94 returns the races 66, 58 to an axially aligned position where the engaging features 90 reengage. This forces the clutch 54 back to the neutral or disengaged position shown in FIG. 7.

FIG. 17 illustrates another embodiment of an electrically actuated mechanical clutch assembly 200 of the invention. The assembly 200 is similar in structure and operation to the assembly 50, with like parts given like reference numerals. However, the spring 230 is captured between the stop ring 298 and a shoulder 204 formed in the shaft 70, instead of being captured between the inner race 66 and the stop ring 98 as is the case in the assembly 50. In the assembly 200, the stop ring 298 includes an extension arm 208 that directly engages and moves the inner race 66 upon axial movement of the stop ring 298 to the clutch engaging position (left in FIG. 17).

In each of the illustrated embodiments, the actuation of the clutch assembly occurs by a spreading apart of at least two rings that are supported about the shaft and that occurs due to the relative rotation between the at least two rings. In the embodiment shown in FIGS. 1-6, the wave rings 8 and 9 are free to rotate with the shaft 1, and the actuator rings 4 and 5 can be stopped by the armature of the solenoid 3 to create relative rotation between at least one of the wave rings 8, 9 and at least one of the actuator rings 4, 5. The relative rotation causes spreading of at least one of the actuator rings 4, 5, and at least one of the wave rings 8, 9 (see FIGS. 5 and 6). This spreading action engages the clutch.

Likewise, in the assemblies 50 and 200, the cam ring 114 rotates with the shaft 70 and the stop ring 98, 298 can be stopped by the actuator rod 138 to create relative rotation between the cam ring 114 and the stop ring 98, 298. The relative rotation causes the stop ring 98, 298 and the cam ring 114 to spread apart (see FIG. 11 and the phantom line representation in FIG. 10), thereby engaging the clutch 54.

Furthermore, each of the illustrated embodiments includes at least two springs with differing spring forces to enable the proper actuation and resetting of the actuator assemblies. In the embodiment of FIGS. 1-6, the springs 10 and 11 are utilized to bias the rings toward a non-spread-apart configuration. In the assembly 50, the springs 94 and 130 are utilized to bias the rings toward a non-spread-apart configuration. In the assembly 200, the springs 94 and 230 are utilized to bias the rings toward a non-spread-apart configuration.

The illustrated axial actuators have broad application in vehicle drive trains, including use in axles, transfer cases, and transmissions. However, the invention can also be used in other applications that utilize electrically actuated mechanical actuators.

Various features of the invention are set forth in the following claims.

1. An axial actuator assembly coupled with a cylindrical member, the axial actuator assembly comprising:
a first ring positioned about the cylindrical member, the first ring including a first surface;
a second ring positioned about the cylindrical member, the second ring including a first surface engaged with the first surface of the first ring; and
an actuator operable to cause relative rotation between the first and second rings to spread the first and second rings apart.

2. The axial actuator assembly of claim 1, wherein at least one of the first surfaces defines a substantially sinusoidal profile.

3. The axial actuator assembly of claim 1, wherein the first surfaces are in nested relation when the first and second rings are not spread apart, and are rotated out of nested relation to spread the first and second rings apart.

4. The axial actuator assembly of claim 1, wherein the first ring includes a projection selectively engageable with the actuator to prevent rotation of the first ring.

5. The axial actuator assembly of claim 4, wherein the second ring rotates when the first ring is prevented from rotating by the actuator.

6. The axial actuator assembly of claim 1, wherein the actuator moves radially with respect to the cylindrical member to cause relative rotation between the first and second rings, and wherein the first and second rings spread apart axially with respect to the cylindrical member.

7. The axial actuator assembly of claim 1, wherein the first ring is positioned about the cylindrical member to be rotatable with respect to the cylindrical member, and the second ring is fixed to the cylindrical member for rotation therewith.

8. The axial actuator assembly of claim 1, further comprising:
a reset member configured to engage one of the first and second rings to create relative rotation between the first and second rings that causes the first and second rings to return to a non-spread-apart configuration.

9. The axial actuator assembly of claim 8, wherein the reset member is spaced axially and rotationally from the actuator.

10. The axial actuator assembly of claim 1, wherein the first and second rings are biased toward a non-spread-apart configuration.

11. The axial actuator assembly of claim 1, further comprising:
a first spring having a first spring force; and
a second spring having a second spring force different from the first spring force;
wherein the first and second springs bias the first and second rings toward a non-spread-apart configuration.

12. A mechanical clutch assembly comprising:
a drive member;
a driven member spaced from the drive member; and
an actuator assembly operable to selectively engage the drive member and the driven member, the actuator assembly including;
a first ring positioned about the drive member, the first ring including a first surface;
a second ring positioned about the drive member, the second ring including a first surface engaged with the first surface of the first ring; and
an actuator operable to cause relative rotation between the first and second rings to spread the first and second rings apart, thereby causing engagement of the drive member and the driven member.

13. The mechanical clutch assembly of claim 12, wherein at least one of the first surfaces defines a substantially sinusoidal profile.

14. The mechanical clutch assembly of claim 12, wherein the first surfaces are in nested relation when the first and second rings are not spread apart, and are rotated out of nested relation to spread the first and second rings apart.

15. The mechanical clutch assembly of claim 12, wherein the first ring includes a projection selectively engageable with the actuator to prevent rotation of the first ring.

16. The mechanical clutch assembly of claim 15, wherein the second ring rotates when the first ring is prevented from rotating by the actuator.

17. The mechanical clutch assembly of claim 12, wherein the actuator moves radially with respect to the drive member to cause relative rotation between the first and second rings, and wherein the first and second rings spread apart axially with respect to the drive member.

18. The mechanical clutch assembly of claim 12, wherein the first ring is positioned about the drive member to be rotatable with respect to the drive member, and the second ring is fixed to the drive member for rotation therewith.

19. The mechanical clutch assembly of claim 12, further comprising:
a reset member configured to engage one of the first and second rings to create relative rotation between the first and second rings that causes the first and second rings to return to a non-spread-apart configuration.

20. The mechanical clutch assembly of claim 19, wherein the reset member is spaced axially and rotationally from the actuator.

21. The mechanical clutch assembly of claim 12, wherein the first and second rings are biased toward a non-spread-apart configuration.

22. The axial mechanical clutch assembly of claim 12, further comprising:
a first spring having a first spring force; and
a second spring having a second spring force different from the first spring force;
wherein the first and second springs bias the first and second rings toward a non-spread-apart configuration.

23. The mechanical clutch assembly of claim 12, further comprising a roller clutch having an inner race positioned about the drive member and an outer race positioned within the driven member, and a plurality of rollers between the inner race and the outer race, and wherein the roller clutch engages the drive member and the driven member when the first and second rings are spread apart.

24. The mechanical clutch assembly of claim 23, wherein the inner race of the roller clutch is moved relative to the outer race by the spreading apart of the first and second rings, the relative movement of the inner race causing the roller clutch to engage the drive member and the driven member.

25. A method of operating an axial actuator assembly supported on a cylindrical member, the axial actuator assembly including first and second rings positioned about the cylindrical member, the first and second rings including respective first surfaces engaging one another, the method comprising:
creating relative rotation between the first and second rings, the relative rotation causing the first and second rings to spread apart from one another.

26. The method of claim 25, wherein creating relative rotation includes:
providing an actuator engageable with one of the first and second rings; and
engaging one of the first and second rings with the actuator to prevent rotation of the one of the first and second rings engaged by the actuator.

27. The method of claim 25, wherein creating relative rotation to cause the first and second rings to spread apart includes:
providing the first surfaces of the rings with profiles that enable the first surfaces to be in nested relation when the rings are in a first relative rotational orientation; and
rotating the rings out of the first relative rotational orientation such that the first surfaces are no longer in nested relation.

28. The method of claim 25, wherein the axial actuator assembly operates a roller clutch having an inner race, an outer race, and a plurality of rollers positioned between the inner race and the outer race, and wherein spreading the first and second rings apart engages the roller clutch.

29. The method of claim 28, wherein spreading the first and second rings apart causes the inner race to be moved relative to the outer race to engage the roller clutch.
